(19) United States
(12) Patent Application Publication
(10) Pub. No.: US 2010/0016201 A1
(43) Pub. Date: Jan. 21, 2010

(54) Graffiti Cleaning Composition

(76) Inventor: Marco Antonio De La Barrera Barriga, Jalisco (MX)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(21) Appl. No.: 12/531,066

(22) PCT Filed: Mar. 13, 2007
(86) PCT No.: PCT/MX07/00037

§ 371 Date: Sep. 12, 2009

(51) Int. Cl. C11D 1/74

(52) U.S. Cl. 510/174

(57) ABSTRACT

The invention relates to a cleaning composition characterized in that it can be used to clean graffiti from, inter alia, flexible, elastic and solid surfaces and synthetic fabrics printed with a selection of colors, silk-screen printed, painted with oil, vinyl or latex paint, automotive paint, as well as surfaces decorated with artistic patinas, metal surfaces with electrostatic paint, baked-on paint. One main advantage of the cleaning composition is that it cleans graffiti without removing paint from the printed matter or damaging the original underlying paint.

### BACKGROUND OF INVENTION

1. Field of Invention

This invention relates to cleaning compositions and more specifically to a 100% ecologic and biodegradable composition to clean graffiti marked over substrates of different kinds and materials.

2. Related Prior Art

A growing amount of graffiti around the cities is observed, any surface is a target for this problem, namely schools, monuments, commercial banners, and private and public buildings, among universal patrimonies such as colonial, indigenous, classic, and contemporary architecture. It can be also observed that this tendency affects not only all of the above mentioned, but also cars and transport driver fleet such as trailers, trains, and private vehicles, increasing the amount of surfaces of bill-boards, or wide format graphics with entrepreneurial advertising, printed advertising in auto transportation, on which our attention is greatly attracted.

Graffiti represents to a great extent a part of our daily living and the acts of those devoted to such illegal activity economically affect cities, families, and companies.

In view of the increasing growth of the acts of vandalism of this nature, a cleaning agent capable of cleaning graffiti from painted or printed surfaces has been developed, as they are the greatest amount of the surfaces affected by this problem. Additionally, it was sought that the cleaning agent had a great degreasing power to be able to alternatively clean other surfaces such as kitchens, engines, furniture, containers, restrooms, refrigerators, as well as fabrics and coatings, which although they have not been attacked with graffiti they might have some kind of grease or dirt and could be cleaned without any toxicological risk.

In checking out the mode of application and the results in most of the similar products around the market, as well as other patented products which are analyzed hereinafter, it was noted a common pattern, they are made of natural aromatic solvents, aliphatic, chlorinated or acid, and they are limited to cleaning graffiti from specific surfaces and having the inconvenience that once the graffiti is removed, such products also affect the underlying paint.

In addition, it can be observed that over solid surfaces on which certain cleaning products were used to remove the graffiti, for example, on top of common use paint or large format printings, even if they remove the graffiti of a great amount of surfaces, they also affect the ordinary painting and distort large format printings printed by water or solvent based paints.

It can be observed that the most of the analyzed products contain very aggressive solvents for the environment such as toluene, xylene, N-Methyl₂pyrrolidone NMP, which besides have irreversible effects over polycarbonate, acrylic, oil based paints, latex based paints, and mostly irreparably affect wall paints and rub out large format printings. All that added to the fact that, as mentioned hereinbefore, such products cause serious damage to the environment and users thereof.

There exist other products including acids and gels containing solvents as MEK (Methyl Ethyl Acetate), which are also very aggressive for the user and the environment. As distinguished from the latter, the new graffiti cleaner proposed does not include MEK.

On the other hand, the cleaning methods and products using a gel are unpractical because the operation for a correct elimination of the remover which cleans the graffiti is more expensive than the cleaner itself.

Other products based on chloride hydrocarbons or phosphates are known, which are harmful to the environment. The present invention does not have any chloride hydrocarbon or phosphates.

Graffiti mainly consists of spray paint and indelible inks. Spray paints are mostly alkyd enamels of short-chains of soy with pigments of mineral base or synthetic dyes while the indelible ink of markers of this type is of a solvent base and uses xylene as carrier and they deposit the mineral or synthetic dye by applying a friction-abrasion on the substrate.

The U.S. Pat. No. 4,353,745 describes an aqueous formula which produces clear protective coating, presumably transparent, over a great variety of surfaces, which formulation substantially comprises a suspension of vinylidene, ethylene glycol, monoethyl ether of ethylene glycol, butyl ethyl ether of ethylene glycol, halogenated polysilane surfactants, a corrosion inhibitor based on sodium benzoate, an defrother (mineral oil in monoehtyl ether of ethylene glycol) and water. Besides, in this patent document a cleaning and printing composition is also proposed for the removal of graffiti and the protecting coating. The latter preferably consists of monoethyl ether of ethylene glycol, methylene chloride, nonylphenol ethoxylate, triethanolamine and water.

The fundamental differences of the new cleaning composition in comparison with the above described one are that the new formulation does not form any type of coating or film once applied, and does not contain any of the aforementioned compounds, nor chlorinated products.

In turn, the U.S. Pat. No. 4,329,247 refers to a composition and method to eliminate stains in vinyl materials, wherein such composition includes the use of a solvent derived of the mono alkyl ether of ethylene glycol and acetates of mono alkyl ether of ethylene glycol together with an aqueous solution of sodium hypochlorite or chloride hypochlorite in molten silica. This cleaning composition is described as highly useful to remove stains, particularly inks and other accidentally applied stains or graffiti applied over vinyl surfaces.

In comparison with the formulation in the patent cited hereinbefore, the new cleaning composition does not include solvents of the type mentioned above, nor chlorinated products. Another important difference is that our product is not a remover but a cleaner which use is not limited to cleaning only vinyl surfaces. Another substantial difference between the new composition and the patented formula is that ours cleans graffiti selectively without affecting the underlying vinyl material, that is, cleans the graffiti of a banner without affecting the color or gloss of the underlying paint.

In the U.S. patent document No. 2004/0058833 a graffiti removing, stain cleaning and degreasing composition is described, which is proposed as a cleaning compound free of turpentine, with an oil-soluble anionic surfactant, a water-soluble anionic surfactant, a prime solvent consisting of an alkyd ester C₁₋₄, a short-chain co-surfactant and water.

Among others, an evident difference between above-proposed formulation and the present invention is that the latter does not include alkyd ester C₁₋₄. In addition, our formulation is not a remover but rather a cleaning composition which selectively removes graffiti without affecting the underlying surface or paint.

Another document related to this type of cleaning compositions is U.S. Pat. No. 6,821,937, which discloses a cleaner for hard surfaces, free of turpentine, which includes an alkyd ester C₁-C₄, of a saturated or unsaturated carboxylic acid C₆-C₂₂ and a surfactant with hydrophilic-lipophilic balance (HLB) from 4 to 10.

It is concluded that our formulation does not use the aforementioned compounds and it is limited to the cleaning of hard surfaces as in the case of the patented formula. The new formulation is capable of cleaning fabrics, synthetic weaves, flexible substrates, plastics, among another wide variety of surfaces, and also our formulation is not restricted to the cleaning of graffiti, but is also useful for the cleaning of animal, vegetal or mineral greases, among other applications. Even, the new formulation does not depend of the ranges of HLB cited in the aforesaid patent for yielding the results mentioned above.

Another cleaning composition is described in the U.S. Pat. No. 5,691,290 which refers to a cleaner for removing undesired paint, graffiti or any other coating of a substrate, said cleaner composition being characterized by mainly consisting of a 40 to 90% by weight of n-methyl-2-pyrrolidone, and 10 to 60% by weight of triester of glycerol of a saturated aliphatic monocarboxylic acid C₁-C₄.

It is known that at least the n-methyl-2-pyrrolidone compound is a product of delicate usage, which may cause irreversible effects in paints, plastics, acrylic polycarbonates and that it is easily absorbed by human skin. Unlike the formula described in the U.S. patent '290, the proposed new composition does not use any of the aforementioned components, nor others suggested in this patent document.

Likewise, our formulation is not restricted to cleaning graffiti in walls but also it may be used even to clean fabrics and synthetic weaves, flexible substrates, plastics, among a great variety of surfaces, and besides it may be used with better results for the cleaning of animal, vegetal or mineral grease, among other multiple possible applications.

On the other hand, the International publication WO 02/064688 discloses a graffiti cleaning compound applied over a solid surface, which consists of at least of one alkyd lactate, Dimethyl sulfoxide (DMSO), at least one anionic tensoactive agent and/or ionic tensoactive agent and water. In addition to the constitutive differences between the formulation of the aforementioned publication and the new proposed formulation, the performance of both is notoriously different since as mentioned above, our formulation removes graffiti selectively from any material without affecting the underlying paint, and the printed graphic or underlying paint in the attacked material is not damaged. Likewise, the new cleaning composition is characterized because it can be used also for the removal of grease stains and other dirt which have been deposited over other materials, for example, textiles.

In addition, according to said international publication the cleaning formulation may contain phosphates and our formulation does not include this kind of compounds. It does not include Dimethyl sulfoxide (DMSO) either.

As of the performance of the study of the aforementioned formulas which have been developed previously for the same purpose, it is concluded that neither one of them has the same constitutive characteristics and performance than our formula.

### SUMMARY OF INVENTION

The main objective of this invention is to deliver a cleaning composition of high effectiveness on the cleaning of graffiti with a minimum impact to the environment, which allows to eradicate graffiti from paint or a colored wide range advertisement banner without damaging the graphic and without affecting the underlying paint.

Another objective of the invention is to propose an effective cleaning composition to remove applied graffiti on solid, hard, flexible, rigid surfaces of different materials such as concrete, canvas, metals, plastics, and others without damaging not in the least the characteristics of such materials and the paint or underlying print.

Another characteristic of this invention is that it has a nice scent, and may be used without any reserve because 100% of its elements may be or are from vegetal origin, biodegradable, of null toxicity, therefore its use does not imply a health risk.

Another singularity of the new cleaning formula is that besides it may be sued as a degreasing composition for the cleaning of rugs and upholstery damaged by vegetal, mineral or animal grease.

The aforementioned and other advantages of the invention are materialized with one new cleaning composition formulated as follows:
a) from 5 to 65 by weight of an organic solvent derived from soy, such as methyl soyate;
b) from 5 to 45% by weight of an organic solvent derived from corn, such as ethyl lactate;
c) from 1 to 15% by weight of acetone;
d) from 10 to 50% by weight of undecylenic alcohol ethoxylates C11/7 moles derived of jojoba;
e) from 35 to 75% by weight in ethanol derived of sugar cane; and
f) from 1 to 2% by weight of an aroma or perfume or vegetal essence, such as lemon or lavender scent.

### DETAILED DESCRIPTION OF THE PREFERRED EMBODIMENTS OF THE INVENTION

The invention refers to a new graffiti cleaning composition which has been applied to different materials or substrates, which is capable of cleaning the stamps produced by an event of such nature and without damaging the paint or underlying material of the affected area. Such cleaning composition is formulated with a base of vegetal extracts and biodegradable solvents, and as a result is a product with a pleasant aroma.

All ingredients of the composition are soluble in water and its combination produces a transparent heterogeneous mixture with a light yellowish transparent color. The cleaning composition is characterized also because it has an igniting point of 40° C. and because it has null toxicity.

In a preferred modality of the invention, the cleaning composition may be formulated according to the specifications given on the following example:

### EXAMPLE 1

a) from 5 to 65 by weight of an organic solvent derived from soy, such as methyl soyate;
b) from 5 to 45% by weight of an organic solvent derived from corn, such as ethyl lactate;
c) from 1 to 15% by weight of acetone;
d) from 10 to 50% by weight of undecylenic alcohol ethoxylates C11/7 moles derived of jojoba;
e) from 35 to 75% by weight in ethanol derived of sugar cane; and
f) from 1 to 2% by weight of an aromatic agent of natural origin.

Additionally, the cleaning composition herein before exemplified may include certain or several optional ingredients: one or more adjuvant non-ionic surfactants and at least one anionic tensionactive agent to form the suspension of oil and water which is dispersed in alcohol, which would have a neutral electric charge which would allow both positive and negative charges, proper of the different types of graffiti, greases, or dirt or be removed, because each one of these products has different charges, at the end of the interaction, the encapsulation of the graffiti or grease in micelles when rinsed to remove the material which is to be removed.

The new cleaning composition is highly effective to clean graffiti applied in acrylic or alkyd spray, industrial paraffinic crayon, and indelible ink markers, in the case of the last, preferably recently applied, without affecting the underlying paint, of any surface, specially automotive paints, alkyd enamels, oil paints, vinyl paint, latex paint, acrylic sealant, and polyurethane pains and coverings, epoxy, baked on paint and electrostatic.

By means of the new cleaning composition graffiti is cleansed and removed aforementioned form printed surfaces with selected color inks CMYK, printed in or by wide range printing equipments of high resolution with water based or solvent based inks, without removing the paint of the print or graphic form the surface printed with ink, for example, Vutek®, Xitex®, Indigo®, Nuhr®, HP®, Epson®, and similar inks printed on self adherent vinyl, canvas, Trovicel®, Coroplast®, metallic plate, pvc, styrene, polystyrene, polypropylene, self adherent labeling vinyl, reflectant vinyl, high performance vinyl, custom vinyl, by means of painting process by serigraphy, ink injection and offset.

To prove the kindness of this invention, the cleaning composition has been proved at least on the following materials; sealed bricks with transparent acrylic, marble, granite, oil paint, alkyd paint, latex paint, rigid aliphatic polyurethanes, semi-rigid, flexible transparent, and in beige, red, white colors, aromatic polyurethane, PVC, flat virgin concrete, sealed concrete, recent model automotive paint, cargo vehicles paint, self adherent vinyl of several brands and qualities printed in color selection CMYK with water based inks and solvent based inks, rubbery canvas of several brands and qualities printed in color selection CMYK with water based and solvent based inks, virgin and printed plastic substrates, road signs, polypropylene baths, stainless steel, bus windows, acrylic, polycarbonate, Trovicel®, styrene, polystyrene, synthetic rugs, acrylic nails, suede shoes, industrial and domestic kitchens, refrigerated trailers.

It has been proved that the cleaning composition is effectively useful as a graffiti cleaner applied in hard surfaces, vinyl surfaces, solid surfaces, flexible surfaces, elastic surfaces, soft, synthetic weaves, surfaces printed with water based and solvent based vinyl inks in color selection CMYK, etc.

According to the experiments of the cleaning composition made on the aforementioned different materials, a preferred formula may be constituted by the elements and included within the values hereinafter mentioned:

### EXAMPLE 2

a) approximately 50% by weight of an organic solvent derived of soy such as methyl soyate;
b) approximately 50% by weight of an organic solvent derived of corn, such as ethyl lactate;
c) approximately 10% by weight of acetone;
d) approximately 50% by weight of undecylenic alcohol ethoxylates C11/7 moles derived of jojoba;
e) approximately 70% by weight in ethanol derived of sugar cane; and
f) approximately 2% by weight of an aromatic agent of natural origin.

### Method of Use.

According to this invention, in a sampling procedure to clean a surface marked with graffiti, using therefore the new cleaning composition, it is recommended to follow the following steps:

1. Apply the new cleaning product directly over the surface or material to be cleaned which has been attacked with graffiti. Such application may be by means of an atomizer, sprayed, or any other convenient manner.

2. Rub the surface to be cleaned with the proper accessory, for example, a cloth which does not loose color, burlap, synthetic fiber, brush, sponge, etc., depending on the hardness of the graffiti and the smoothness of the surface to be recovered. Optionally, any of these elements may be used impregnated with the cleaner rubbing the surface marked with graffiti as many times as needed to remove such.

3. Soak the surface or material which has been cleaned with water, once the graffiti has been removed, to avoid leaving residues.

The removal of graffiti is, in some cases, immediate and others, for example in metallic gates painted with alkyd enamel which have very old graffiti, it is recommended to use a fiber and it might take from 5 to 10 rubs to completely eliminate graffiti.

For the case of cleaning graffiti from a printed surface, it is processed differently than the aforementioned manner. It is recommended to use rubber gloves and liquid to avoid generating abrasion on the printed graphic and in the event of solvent based inks the cleaner may be diluted with water in a way that the intensity thereof is regulated to avoid affecting the inks when such are delicate.

Following, the times gather which, according to the testing of the product on certain substrates, may take for the process to completely remove graffiti, manually:
Printed vinyl in color selection: Immediate
Printed canvas in color selection: Immediate
Sealed brick: 1 min.
Granite: Immediate.
Stainless Steel: Immediate.
Oil paint: Immediate.
Vinyl paint: 1 minute.
Non-cavernous virgin flat concrete: 3 impregnations of 1 minute.
Polycarbonate: Immediate.

As mentioned before, at the end of the cleaning, always and in every case, it should be rinsed with water so avoid leaving residues of the removed material.

In most of the cases, the test cleaning was made of surfaces on the street where graffiti has more than one month from being applied. In other tests performed, black, white, red and phosphorescent orange graffiti of several brands and qualities was previously applied over certain materials to be able to attain a wider sample of the performance of the cleaner. Even though the number of rubs required to eradicate graffiti may vary, the results were highly satisfactory.

As mentioned before, it was proved that the cleaning composition also removes graffiti applied on several kinds of printed graphics, such as polystyrene, PVC, polyvinyl, polyurethane, polystyrene, styrene, acrylic, as well as surfaces sensitive to common solvents such as glasses, mirrors, stainless steel, and polycarbonate, without damaging them.

Even though in the tests performed it was decided to apply the cleaning composition manually, it shall be obvious that the methodology of use may include any type of aerosol applying system, atomizer, HVLP sprinkling, suction gun, ultrasound brush, manual brush with bristles of any type of fiber, weaves with coherent weft or without, sponges, strained, direct application in high and low pressure and negative pressure, or any other system adequate therefore.

### Other Applications of the Cleaning Composition.

As a result of the tests performed, another particularity of the cleaning composition is that it may be used also to eliminate residual paint of scratches in automotive paint resulting of the friction of a motor vehicle against another, slight scratches which afterwards show the color of the automobile which produced the damage. With the application of the cleaning composition formulated as described before, scratches of paint in vehicles have been eliminated without affecting the glow of the underlying car paint, leaving it intact.

Another particular which the cleaning composition has is an excellent degreasing power able to eradicate dirt of animal, grease, mineral grease, and vegetal grease from any surface stained with it. Therefore, the invention may be used also as an excellent cleaner, for example, for rugs, and synthetic upholstery.

Another application with proven results of the invention is that it may also be used as an excellent product to remove nail polish.

It is important to point out that the cleaning composition which has been described herein before, shall not be restricted in its use to those specifically stated herein as examples, like graffiti cleaning and grease cleaning, due to the fact that because of its effectiveness and proven results its use may extend favorably to other fields where non toxic cleaners are required. For example, the cleaning composition is useful for cleaning kitchens, ovens, microwaves, sinks, trash cans, common use tools, workshops for engine cleaning, automotive parts, and even to clean and/or restore car paint, without affecting its original glow, damaged by superficial scratches of paint which are commonly caused by other cars.

As described herein before, the difference with most of the other existing similar products, is that the new cleaning composition is characterizes because it is free of chlorinated hydrocarbon and phosphates.

Even though the invention has been described in the context of the modality or preferred form of performance, for the specialists on the matter it shall be evident that the scope of the exemplified concept extends beyond the specifically described formula into other possible alternate modalities and/or uses of the invention which are feasible or doable. Besides, even when the invention has been described in detail, any expert in the technology filed to which the invention belongs, may infer that certain constitutive elements of the composition may be replaces or else others different may be included to the light of the description which precedes without such modifying in essence the result for which such was conceived.

Taking into consideration the aforementioned, it shall be acknowledged that several elements of the cleaning formula may be combined with others or substituted by other to shape alternate modes of performance which led to the same result. This way, it is intended that the scope of this invention is not interpreted as limited by the modality particularly described, but that such range shall be defined by a reasonable interpretation of the following claims.

1. Cleaning composition based on vegetal extracts and biodegradable solvents, of pleasant aroma, which cleans graffiti applied by acrylic aerosol or alkyd, paraffinic industrial crayon, or indelible ink markers on any surface of a wide range of materials without affecting the underlying paint; said cleaning composition comprising:
a) from 5 to 65 by weight of an organic solvent derived from soy, such as methyl soyate;
b) from 5 to 45% by weight of an organic solvent derived from corn, such as ethyl lactate;
c) from 1 to 15% by weight of acetone;
d) from 10 to 50% by weight of undecylenic alcohol ethoxylates C11/7 moles derived of jojoba;
e) from 35 to 75% by weight in ethanol derived of sugar cane; and
f) from 1 to 2% by weight of an aromatic vegetal essence.

2. The cleaning composition of claim 1, wherein all the ingredients thereof are soluble in water.

3. The cleaning composition of claim 1, wherein said composition results in a heterogeneous transparent mixture with a light yellowish transparent tone.

4. The cleaning composition of claim 1, further including at least an anionic tensoactive agent which allows to form an emulsion of oil and water and is dissipated in alcohol for the encapsulation of the graffiti or grease product in micelles to be removed from the material which is to be cleaned.

5. The cleaning composition of claim 1, wherein said composition has an igniting point of 40° C.

6. The cleaning composition of claim 1, wherein said composition is of null toxicity.

7. The cleaning composition of claim 1, wherein said composition is free of chlorinated hydrocarbon.

8. The cleaning composition of claim 1, wherein said composition is free of phosphates.

9. The cleaning composition of claim 1, which may also be used to clean grease stains on textiles, like rugs and upholstery.

10. A cleaning composition, comprising:
a) approximately 50% of the weight of an organic solvent derived of soy such as methyl soyate;
b) approximately 15% of the weight of an organic solvent derived of corn, such as ethyl lactate;
c) approximately 10% in weight of acetone;
d) approximately 50% in weight of undecylenic alcohol ethoxylates C11/7 moles derived of jojoba;
e) approximately 70% weight in ethanol derived of sugar cane; and
f) approximately 2% in weight of an aromatic vegetal essence.
